(19) United States
(12) Patent Application Publication
(10) Pub. No.: US 2017/0059789 A1
(43) Pub. Date: Mar. 2, 2017

(54) FERRULE FOR OPTICAL CONNECTORS

(71) Applicant: TYCO ELECTRONICS CORPORATION, Berwyn, PA (US)

(72) Inventors: Jason Thomas CHIOTA, Harrisburg, PA (US); Daniel Wesley FLEMMENS, York, PA (US); Aleksandar Kolev ANGELOV, Harrisburg, PA (US); Michael Joseph VINO, Landisville, PA (US); Craig Warren HORNUNG, Harrisburg, PA (US); Michael Fredrick LAUB, Enola, PA (US); Chad MORGAN, Carneys Point, NJ (US); Alan PLOTTS, Harrisburg, PA (US)

(21) Appl. No.: 15/247,240

(22) Filed: Aug. 25, 2016

Related U.S. Application Data
(60) Provisional application No. 62/211,181, filed on Aug. 28, 2015.

(51) Int. Cl. G02B 6/38

(52) U.S. Cl. CPC G02B 6/3885; G02B 6/3882; G02B 6/3838

(57) ABSTRACT

A ferrule for optical connectors. The ferrule includes a mating face for mating with a mating ferrule. Fiber receiving openings extend through the mating face. A protrusion surface extends from the mating face. The protrusion surface surrounds the fiber receiving openings, wherein all of the fiber receiving openings extend through the protrusion surface of the mating face. A top surface of the ferrule has an opening, the opening is positioned proximate to the mating face. A fiber positioning member is positioned in the ferrule, the fiber positioning member has channels which cooperate with individual fibers to properly position and retain the fibers in the ferrule. The channels have tapered surfaces which guide the fibers into the channels smoothly without the fiber abutting on the wall of the channels.

### CROSS-REFERENCES TO RELATED APPLICATIONS

This application claims the priority of Untied States provisional patent application No. 62/211,181 filed Aug. 28, 2015, incorporated herein by reference in its entirety.

### FIELD OF THE INVENTION

The present invention relates to a ferrule for optical connectors used for a connecting optical fibers in optical communications. In particular, the invention is directed to a ferrule which accommodates automatable fiber assembly and precision alignment of the fibers.

### BACKGROUND OF THE INVENTION

The current state of optical connectors for both the passive and active markets are expensive to manufacture due to the design of molded components not allowing for automation and relying solely on manual labor intensive processes. These components require an operator to manually assemble multi-fiber configurations into tightly controlled precision fiber bore diameters in the realm of a few hundred microns and below. The current design of such ferrules is not conducive to allow for automation of the fiber termination process which results in high manufacturing costs of the connector assembly.

It would, therefore, be beneficial to provide a ferrule which provides an automatable solution for fiber insertion and termination of precision optical connector components. It would be beneficial to provide such a ferrule without sacrificing tight tolerances which enable part functionality, thereby reducing the applied costs in the manufacturing process.

### SUMMARY OF THE INVENTION

An object is to provide a ferrule which accommodates automatable fiber assembly.

An object is to provide a ferrule which includes a small protrusion surface area surrounding the fiber core holes on the mating face or endface of the ferrule. In one illustrative embodiment, the protrusion surface extends no more than 25 microns from the endface of the ferrule. In one illustrative embodiment, the protrusion surface has targeted flatness values of less than five microns. In one illustrative embodiment, the protrusion surface is less than 15 percent of a surface area of the mating face.

An object is to provide a ferrule in which the ferrule window is enlarged and moved closer to the endface of the ferrule to allow for automatic insertion of fibers within the fiber bore holes.

An object is to provide a ferrule in which the backend of the ferrule contains lead-ins around the perimeter of the external ferrule to accommodate for automatic insertion of fibers.

An object is to provide a ferrule which is versatile to allow for sub-assembly into a multitude of optical connector housings.

An object is to provide a ferrule which can be utilized in conjunction with a no polish, optical fiber interconnect assembly.

An embodiment is directed to a ferrule for optical connectors. The ferrule includes a mating face for mating with a mating ferrule. Fiber receiving openings extend through the mating face. A protrusion surface extends from the mating face. The protrusion surface surrounds the fiber receiving openings, wherein all of the fiber receiving openings extend through the protrusion surface of the mating face.

An embodiment is directed to a ferrule for optical connectors. The ferrule includes a mating face for mating with a mating ferrule. Fiber receiving openings extend through the mating face. A protrusion surface extends from the mating face. The protrusion surface surrounds the fiber receiving openings. A surface area of the protrusion surface is less than 15 percent of a surface area of the mating face.

An embodiment is directed to a ferrule for optical connectors in which the protrusion surface extends no more than 25 microns from the mating face. An embodiment is directed to a ferrule in which the protrusion surface has a flatness value of less than five microns.

An embodiment is directed to a ferrule for optical connectors. The ferrule includes a mating face for mating with a mating ferrule. Fiber receiving openings extend through the mating face. A protrusion surface extends from the mating face. The protrusion surface surrounds the fiber receiving openings. A top surface of the ferrule has an opening, the opening is positioned proximate to the mating face. A fiber positioning member is positioned in the ferrule, the fiber positioning member has channels which cooperate with individual fibers to properly position and retain the fibers in the ferrule. The channels have tapered surfaces which guide the fibers into the channels smoothly without the fiber abutting on the wall of the channels.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a front perspective view of an illustrative embodiment of a ferrule of the present invention.

FIG. 2 is an enlarged perspective view of a mating surface of the ferrule of FIG. 1.

FIG. 3 is a top perspective of the ferrule of FIG. 1, illustrating the window which extends through a top surface of the housing.

FIG. 4 is an enlarged top view of an alternate window which extends through the top surface of the housing showing a portion of a fiber positioning member positioned in the housing.

FIG. 5 is a back perspective view of the ferrule of FIG. 1.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

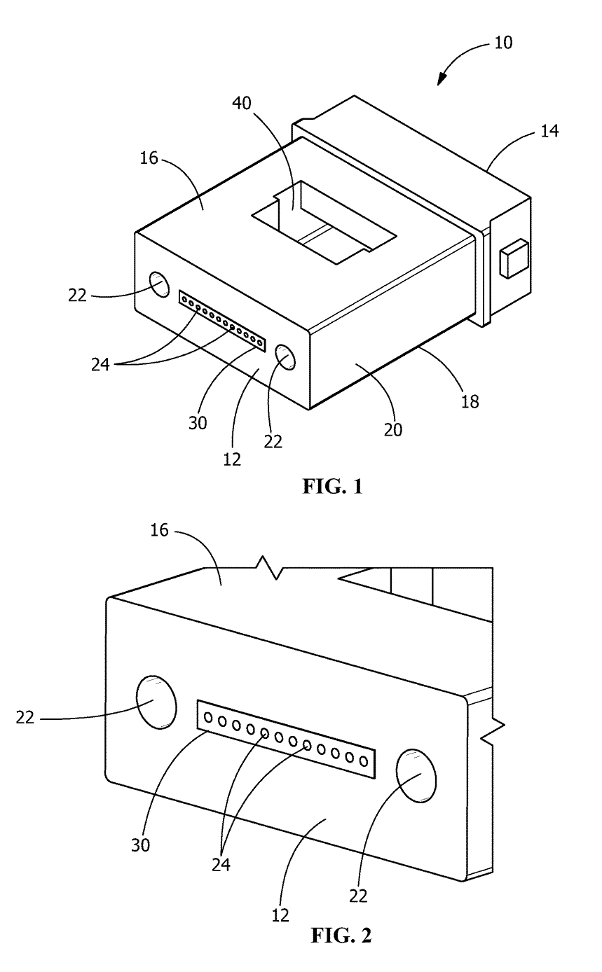

FIGS. 1 through 5 show an illustrative embodiment of a ferrule 10. The ferrule may be molded from various materials, including, but not limited to, thermosetting resin such as epoxy resin or a thermoplastic resin such as liquid crystal polymer and polyphenylene sulfide (PPS).

The ferrule 10 has a mating face or endface 12 and oppositely facing fiber receiving face 14. A top wall 16 and a bottom wall 18 extend between the mating face 12 and the fiber receiving face 14. Sidewalls 20 extend between the mating face 12 and the fiber receiving face 14 and extend from the top wall 16 to the bottom wall 18.

Two alignment pin holes or openings 22 extend through the mating face 12 and through the ferrule 10. The pin holes 22 are dimensioned to receive alignment pins (not shown) which extend through holes of a mating ferrule (not shown). In one illustrative embodiment, the ferrule 10 and the mating ferrule have the same construction. Fiber receiving fixed holes or openings 24 extend through the mating face 12. The fiber receiving openings 24 are formed at a predetermined interval between the two alignment pin holes 22. The fiber receiving openings 24 are arranged so that the center axis lines of the fiber receiving openings 24 and the center axis lines of the alignment pin holes 22 are provided in the same plane. However, other configurations, such as, but not limited to, the center axis lines of the fiber receiving openings 24 being offset from the center axis lines of the alignment pin holes 22 may be used.

Referring to FIGS. 1 and 2, an area or protrusion surface 30 of the mating face 12 is raised relative to the remaining portion of the mating face 12. The protrusion surface 30 surrounds the fiber receiving openings 24, such that all of the fiber receiving openings 24 extend through the protrusion surface 30 of the mating face 12. In one illustrative embodiment, the surface area of the protrusion surface 30 is less than approximately 15 percent of the surface area of the mating face 12. In one illustrative embodiment, the protrusion surface 30 is raised no more than 25 microns from the mating face 30. In one illustrative embodiment, the protrusion surface 30 has a flatness value of less than five microns.

As is currently known in the art, as two ferrules 10 are joined together, the entire respective mating faces 12 are moved together. While flush contact between their abutting mating faces 12 is desired, manufacturing tolerances and material flow (such a warping or bowing) make it difficult to provide the precision desired to place the mating ferrules and their respective fibers in optimum position to minimize loss between the fibers of the respective ferrules.

With known ferrules, as each mating face has a relatively large surface, it is difficult to precisely control the flatness of the mating face during the manufacturing or molding process. Consequently, in known ferrules, the mating faces may have large flatness values of greater than five microns, greater than ten microns, etc. This results in an uneven surface in which a first portion of the mating face of ferrule is spaced from the mating face of the mating ferrule a greater distance than a second portion of the mating face of ferrule is spaced from the mating face of the mating ferrule. The uneven surface may cause various respective mating pairs of fibers to have a greater loss than other mating pairs of fibers in the same mating ferrules.

According to the present invention, the entire surface of the mating face 12 does not need to be precisely controlled. As the protrusion surface 30 is raised, the protrusion surface 30 of ferrule 10 will engage the protrusion surface of the mating ferrule as the ferrules are joined together. As the surface area of the protrusion surface 30 is significantly smaller than the surface area of the mating face 12, the flatness of the protrusion surface 30 can be more precisely controlled at much less cost. As the protrusion surface 30 is better controlled, with a flatness value of five microns or less, and as the ends of the fibers are positioned in the fiber receiving openings 24 which extend through the protrusion surface 30, respective mating fibers are more precisely positioned next to each other. This results in a better alignment between the openings 24 and the fibers. In addition, the space provided between the openings 24 and the ends of the fibers of ferrule 10 and the openings and the ends of the fibers of the mating ferrule are minimized. This results in the loss between the respective fibers and mating fibers being minimized across the entire protrusion surface 30.

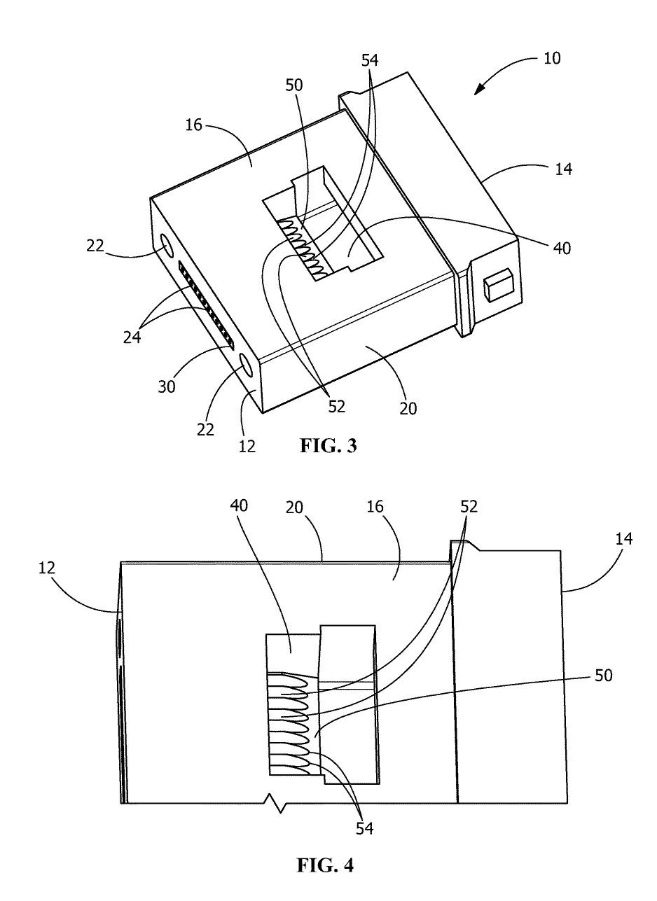

As shown in FIG. 3, top wall 16 has an opening 40 which extends therethrough. The opening 40 is dimensioned to allow a device (not shown) to extend through the opening 40 to manipulate the fibers positioned in the connector.

The opening 40 is enlarged and moved closer to or proximate the mating face 12 of the ferrule 10 when compared to known ferrules. This allows for the fiber receiving openings 24 to be more easily accessed through the opening 40, thereby facilitating the automatic insertion of fibers within the fiber receiving openings 24, such as, for example, by allowing for potential fiber buckling and epoxy of fibers.

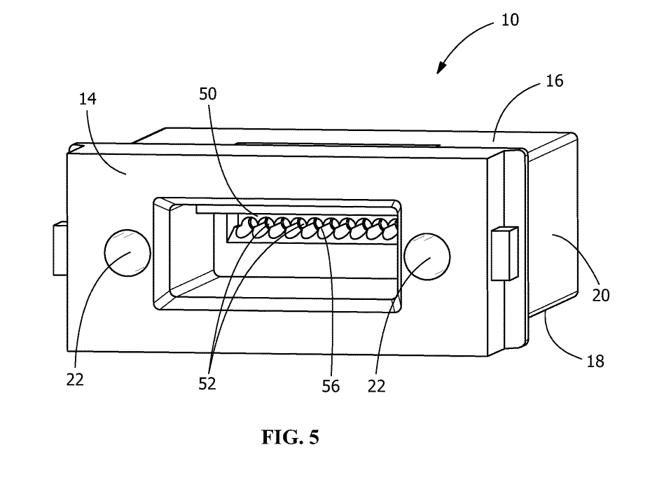

As shown in FIG. 4, a fiber positioning member 50 is positioned in the ferrule 10. The fiber positioning member 50 has channels 52 which cooperate with individual fibers to properly position and retain the fibers in the ferrule. The channels 52 of the fiber positioning member 50 also facilitate the alignment of the fibers with the fiber receiving openings 24. The channels 52 have tapered surfaces or lead-in surfaces 54 proximate the mating face 12 which guide the fibers into the channels 52 smoothly without the fiber abutting on the wall of the channels 52. The tapered surfaces or lead-in surfaces 54 also facilitate the automatic insertion of fibers into the channels 52. In addition, as shown in FIG. 5, the ferrule 10 has tapered surfaces or lead-in surfaces 56 proximate the fiber receiving face 14 which guide the fibers into the channels 52 smoothly without the fiber abutting on the wall of the channels 52. The tapered surfaces or lead-in surfaces 56 also facilitate the automatic insertion of fibers into the channels 52.

The ferrule 10 is configured to accommodate automateable fiber assembly. The molded ferrule contains lead-ins inside the internal geometry of the ferrule to allow automatic insertion of fibers within the fiber receiving openings. The backend of the molded ferrule contains lead-ins around the perimeter of the external ferrule to accommodate for automatic insertion of fibers. The ferrule 10 is versatile to allow for sub-assembly into a multitude of optical connector housings. The ferrule 10 can be utilized in conjunction with a no polish, optical fiber interconnect assembly.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials and components, without departing from the spirit or essential characteristics thereof. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A ferrule for optical connectors, the ferrule comprising:
a mating face for mating with a mating ferrule, fiber receiving openings extend through the mating face;
a protrusion surface extending from the mating face, the protrusion surface surrounds the fiber receiving openings, wherein all of the fiber receiving openings extend through the protrusion surface of the mating face.

2. The ferrule as recited in claim 1, wherein a surface area of the protrusion surface is less than 15 percent of a surface area of the mating face.

3. The ferrule as recited in claim 1, wherein the protrusion surface extends no more than 25 microns from the mating face.

4. The ferrule as recited in claim 1, wherein the protrusion surface has a flatness value of less than five microns.

5. The ferrule as recited in claim 1, wherein a top surface of the ferrule has an opening, the opening is positioned proximate to the mating face wherein the opening facilitates the automatic insertion of fibers within the fiber receiving openings.

6. The ferrule as recited in claim 1, wherein a fiber positioning member is positioned in the ferrule, the fiber positioning member having channels which cooperate with individual fibers to properly position and retain the fibers in the ferrule, the channels having tapered surfaces which guide the fibers into the channels smoothly without the fiber abutting on the wall of the channels.

7. The ferrule as recited in claim 6, wherein the tapered surfaces are provided proximate the mating face.

8. The ferrule as recited in claim 6, wherein the tapered surfaces are provided proximate a fiber receiving face.

9. A ferrule for optical connectors, the ferrule comprising:
a mating face for mating with a mating ferrule, fiber receiving openings extend through the mating face;
a protrusion surface extending from the mating face, a surface area of the protrusion surface is less than 15 percent of a surface area of the mating face.

10. The ferrule as recited in claim 9, wherein the protrusion surface surrounds the fiber receiving openings.

11. The ferrule as recited in claim 9, wherein the protrusion surface extends no more than 25 microns from the mating face.

12. The ferrule as recited in claim 9, wherein the protrusion surface has a flatness value of less than five microns.

13. The ferrule as recited in claim 9, wherein a top surface of the ferrule has an opening, the opening is positioned proximate to the mating face wherein the opening facilitates the automatic insertion of fibers within the fiber receiving openings.

14. The ferrule as recited in claim 9, wherein a fiber positioning member is positioned in the ferrule, the fiber positioning member having channels which cooperate with individual fibers to properly position and retain the fibers in the ferrule, the channels having tapered surfaces which guide the fibers into the channels smoothly without the fiber abutting on the wall of the channels.

15. The ferrule as recited in claim 14, wherein the tapered surfaces are provided proximate the mating face.

16. The ferrule as recited in claim 14, wherein the tapered surfaces are provided proximate a fiber receiving face.

17. A ferrule for optical connectors, the ferrule comprising:
a mating face for mating with a mating ferrule, fiber receiving openings extend through the mating face;
a protrusion surface extending from the mating face, the protrusion surface surrounds the fiber receiving openings;
a top surface of the ferrule having an opening, the opening positioned proximate to the mating face;
a fiber positioning member positioned in the ferrule, the fiber positioning member having channels which cooperate with individual fibers to properly position and retain the fibers in the ferrule, the channels having tapered surfaces which guide the fibers into the channels smoothly without the fiber abutting on the wall of the channels.

18. The ferrule as recited in claim 17, wherein a surface area of the protrusion surface is less than 15 percent of a surface area of the mating face.

19. The ferrule as recited in claim 17, wherein the protrusion surface extends no more than 25 microns from the mating face.

20. The ferrule as recited in claim 17, wherein the protrusion surface has a flatness value of less than five microns.
